(19) United States
(12) Patent Application Publication
(10) Pub. No.: US 2026/0244361 A1
(43) Pub. Date: Aug. 20, 2026

(54) STORAGE DEVICE, OPERATING METHOD OF THE SAME, AND OPERATING METHOD OF ELECTRONIC SYSTEM INCLUDING THE SAME

(71) Applicant: SK hynix Inc., Gyeonggi-do (KR)

(72) Inventors: Sung Jin PARK, Gyeonggi-do (KR); Hoe Seung JUNG, Gyeonggi-do (KR)

(21) Appl. No.: 19/318,373

(22) Filed: Sep. 4, 2025

(30) Foreign Application Priority Data
Feb. 20, 2025 (KR) 10-2025-0022408
Apr. 14, 2025 (KR) 10-2025-0048130

(51) Int. Cl. G06F 3/06

(52) U.S. Cl. CPC G06F 3/0656; G06F 3/0604; G06F 3/0679

(57) ABSTRACT

A storage device includes a first memory device; a second memory device including a first buffer memory configured to store a plurality of mapping segments each including a plurality of logical addresses; and a memory controller configured to perform a map update operation to move the plurality of mapping segments from the second memory device to the first memory device, compute a first variance value of the plurality of logical addresses included in each of the plurality of mapping segments, perform a first comparison operation between the first variance value and a threshold value, and determine whether to perform the map update operation based on a result of the first comparison operation.

### CROSS-REFERENCE TO RELATED APPLICATION

The present application claims priority under 35 U.S.C. § 119(a) to Korean patent application number 10-2025-0022408, filed on Feb. 20, 2025 and Korean patent application number 10-2025-0048130, filed on Apr. 14, 2025, the entire disclosures of which are incorporated herein by reference.

### BACKGROUND

### 1. Technical Field

Various embodiments of the present disclosure generally relate to a storage device, a method of operating the same, and a method of operating an electronic system including the same, and more particularly, to a storage device performing a map update operation, a method of operating the same, and a method of operating an electronic system including the same.

### 2. Related Art

Memory devices store data in response to a write request and output the stored data in response to a read request. For example, memory devices are classified as volatile memory devices, such as Dynamic Random Access Memory (DRAM) and Static RAM (SRAM) devices, which lose stored data when supplied power is interrupted, or non-volatile memory devices, such as flash memory, Phase-change RAM (PRAM), Magnetic RAM (MRAM), and Resistive RAM (RRAM) devices, which retain stored data even when supply of power is interrupted or blocked.

In general, when receiving a logical address from a host device, non-volatile memory devices can temporarily store the logical address in volatile memory rather than immediately storing the same in non-volatile memory. However, due to limitations on the size of the volatile memory, techniques for moving the logical address stored in the volatile memory to the non-volatile memory may be required.

### SUMMARY

Various embodiments of the present disclosure are directed to a storage device performing a map update operation, a method of operating the same, and a method of operating an electronic system including the same.

According to an embodiment of the present disclosure, a storage device is provided. The storage device includes a first memory device; a second memory device including a first buffer memory configured to store a plurality of mapping segments each including a plurality of logical addresses; and a memory controller configured to perform a map update operation to move the plurality of mapping segments from the second memory device to the first memory device, compute a first variance value of the plurality of logical addresses included in each of the plurality of mapping segments, perform a first comparison operation between the first variance value and a threshold value, and determine whether to perform the map update operation based on a result of the first comparison operation.

According to an embodiment of the present disclosure, a method of operating a storage device is provided. The method includes computing, by a memory controller, a first variance value of the plurality of logical addresses included in each of a plurality of mapping segments stored in first buffer memory of a second memory device; receiving, by the memory controller, a host request and a first logical address from an external host device; performing, by the memory controller, a first comparison operation between the first variance value and a threshold value; and performing, by the memory controller, a map update operation in response to determining that the first variance value is greater than the threshold value, wherein the plurality of mapping segments each include a plurality of logical addresses, and wherein the map update operation moves the plurality of mapping segments from the second memory device to a first memory device.

According to an embodiment of the present disclosure, a method of operating an electronic system is provided. The method includes computing, by a storage device, a first variance value of the plurality of logical addresses included in each of a plurality of mapping segments stored in a first buffer memory of a second memory device in the storage device; transferring, by a host device, a host request and a first logical address to the storage device; performing, by the storage device, a first comparison operation between the first variance value and a threshold value in response to receiving the host request and the first logical address from the host device; and performing, by the storage device, a map update operation in response to determining that the first variance value is greater than the threshold value, wherein the plurality of mapping segments each include a plurality of logical addresses, and wherein the map update operation moves the plurality of mapping segments from the second memory device to a first memory device.

### BRIEF DESCRIPTION OF THE DRAWINGS

FIG. 1 is a block diagram of an electronic system according to an embodiment of the present disclosure;

FIG. 2 is a block diagram of a storage device according to an embodiment of the present disclosure;

FIG. 3 is a diagram illustrating variance values of mapping segments according to some embodiments of the present disclosure;

FIG. 4 is a block diagram of a storage device according to some embodiments of the present disclosure;

FIG. 5 is a diagram illustrating a map tree according to some embodiments of the present disclosure;

FIG. 6 is a flowchart illustrating a method of operating a storage device according to embodiments of the present disclosure;

FIG. 7 is a flowchart illustrating a method of operating a storage device according to some embodiments of the present disclosure;

FIG. 8 is a flowchart illustrating a method of operating a storage device according to some embodiments of the present disclosure;

FIG. 9 is a block diagram illustrating a memory card system to which a storage device according to some embodiments of the present disclosure is applied; and

FIG. 10 is a block diagram illustrating an electronic system according to some embodiments of the present disclosure.

### DETAILED DESCRIPTION

Hereinafter, embodiments of the present disclosure are described in a clear and detailed manner to the extent that those skilled in the art can readily implement the embodiments of the present disclosure.

Hereinafter, the terms such as “first” and “second” may be used to describe various components. However, the components should not be limited by these terms. The above terms are used to distinguish one component from another component.

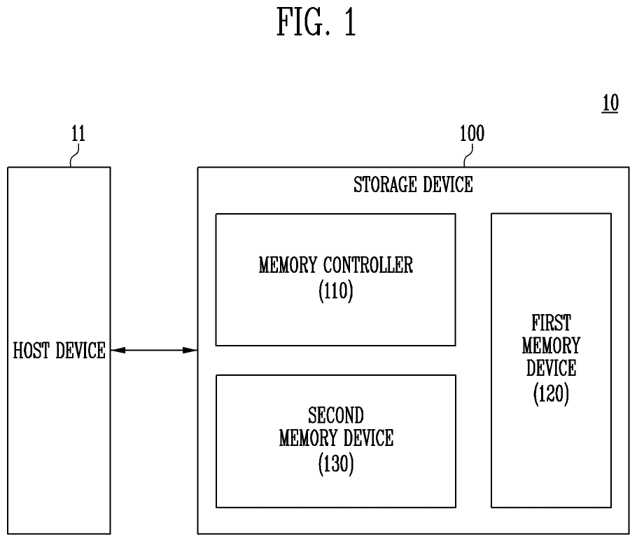

FIG. 1 is a block diagram of an electronic system 10 according to an embodiment of the present disclosure. Referring to FIG. 1, the electronic system 10 may be a computing system configured to process various information and/or store processed information as data. In some embodiments, the electronic system 10 may be implemented as a personal computer (PC), notebook, laptop, server, workstation, tablet PC, smartphone, digital camera, dashcam, or the like.

The electronic system 10 may include a host device 11 and a storage device 100. The host device 11 may control various operations of the electronic system 10. More specifically, the host device 11 may control operations of other components constituting the electronic system 10. The host device 11 may be implemented as a general-purpose processor, a dedicated processor, an application processor (AP), or the like.

The host device 11 may communicate with the storage device 100. For example, the host device 11 may request that the storage device 100 perform a program operation, a read operation, an erase operation, or the like. The host device 11 may transfer, to the storage device 100, a host request, data, and a logical address for a program operation of the storage device 100. The host device 11 may transfer, to the storage device 100, a host request and a logical address for a read operation of the storage device 100.

The storage device 100 may store data. For example, the storage device 100 may store data under the control of the host device 11. In some embodiments, the storage device 100 may include at least one of a solid-state device (SSD), embedded memory, or removable external memory. When the storage device 100 is an SSD, the storage device 100 may be a device which conforms to the Non-Volatile Memory express (NVMe) standard. When the storage device 100 is embedded memory or removable external memory, the storage device 100 may be a device which conforms to the Universal Flash Storage (UFS) or embedded Multi-Media Card (eMMC) standard. The host device 11 and the storage device 100 may each generate packets based on an adopted standard protocol and transfer the generated packets to each other.

The storage device 100 may include a memory controller 110, a first memory device 120, and a second memory device 130. The memory controller 110 may control an operation of the storage device 100. For example, the memory controller 110 may control an operation of the storage device 100 according to an internal policy or in response to a request from the host device 11. The memory controller 110 may store data in the first memory device 120 or read data stored in the first memory device 120 according to an internal policy or in response to a request from the host device 11.

In response to a host request corresponding to a program operation received from the host device 11, the memory controller 110 may generate a program command and provide the generated program command to the first memory device 120. In response to a host request corresponding to a read operation received from the host device 11, the memory controller 110 may generate a read command and provide the generated read command to the first memory device 120. The memory controller 110 may transfer the data read from the first memory device 120 to the host device 11.

The memory controller 110 may store a logical address in the second memory device 130. For example, the memory controller 110 may receive a host request and a logical address from the host device 11, and store the received logical address in the second memory device 130. In some embodiments, the memory controller 110 may store a plurality of logical addresses in the second memory device 130 as a single mapping segment. For example, one logical address may correspond to 4 kilobytes (KB) of data, and one mapping segment may include 1024 logical addresses. However, this is only one embodiment to facilitate the understanding of the present disclosure, and one logical address may correspond to different sizes of data, and one mapping segment may include a different number of logical addresses.

In some embodiments, the memory controller 110 may temporarily store logical addresses or mapping segments including a plurality of logical addresses in the second memory device 130. The memory controller 110 may control the second memory device 130 to move the logical addresses or the mapping segments including the plurality of logical addresses temporarily stored in the second memory device 130 to the first memory device 120. The memory controller 110 controlling the second memory device 130 to move the logical addresses or the mapping segments including the plurality of logical addresses stored in the second memory device 130 to the first memory device 120 may be referred to as a map update operation. After the map update operation is completed, the logical addresses or the mapping segments including the plurality of logical addresses stored in the second memory device 130 may be erased.

The memory controller 110 may perform the map update operation. For example, the memory controller 110 may perform the map update operation when a logical address, which is identical to the logical address received from the host device 11, is stored in the second memory device 130. In some embodiments, the memory controller 110 may perform a search operation on the second memory device 130 to determine whether an address identical to the logical address received from the host device 11 is stored in the second memory device 130.

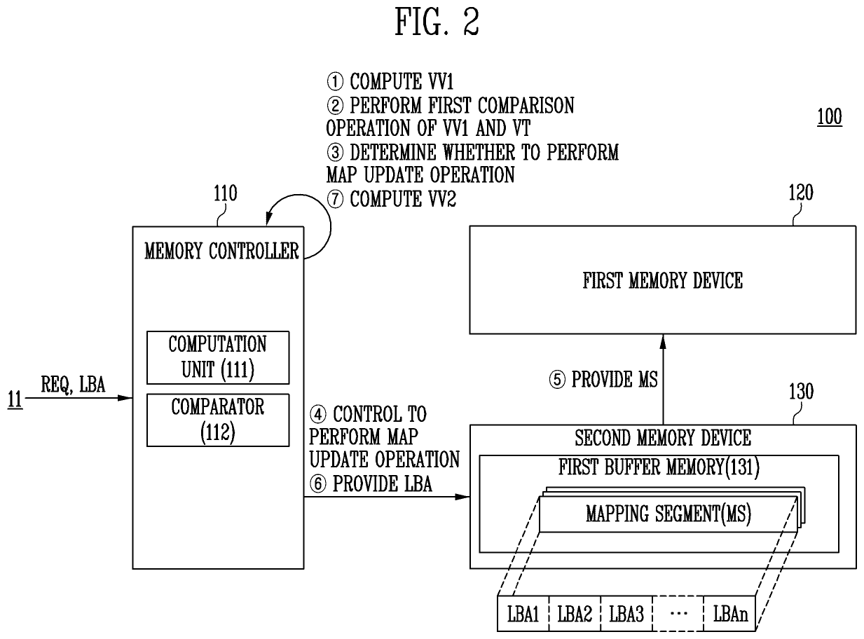

The search operation may be one of a random search, a linear search, or the like. The random search may refer to determining a location of a logical address which is a target of the search operation among logical addresses stored at random locations, and the linear search may refer to determining a location of a logical address which is a target of the search operation among logical addresses in a sequential order. Because the search operation is performed over a fairly large number of logical addresses, it may cause a large overhead. Therefore, it may be desired to minimize or reduce the execution of the search operation to improve the performance of the storage device 100. A more detailed description of the memory controller 110 capable of improving the performance of the storage device 100 by minimizing or reducing the execution of a search operation will be described below with reference to FIG. 2.

The first memory device 120 may store data under the control of the memory controller 110. For example, the first memory device 120 may store user data received from the host device 11 and logical addresses or mapping segments including a plurality of logical addresses received from the second memory device 130 by a map update operation.

The first memory device 120 may be a non-volatile memory device, such as a NAND Flash memory device, but the embodiments of the present disclosure are not limited thereto. The first memory device 120 may be one of various devices which may retain stored data even when the power supply is interrupted, such as a Phase-change Random Access Memory (PRAM), Magnetic Random Access Memory (MRAM), Resistive Random Access Memory (RRAM), Ferroelectric Random Access Memory (FRAM) device, or the like.

The second memory device 130 may store data under the control of the memory controller 110. For example, the second memory device 130 may store logical addresses or mapping segments including a plurality of logical addresses received from the memory controller 110. In some embodiments, the second memory device 130 may temporarily store the logical addresses or the mapping segments and transfer the stored logical addresses or mapping segments to the first memory device 120 by a map update operation.

The second memory device 130 may be one of various devices, such as a Dynamic Random Access Memory (DRAM), Static Random Access Memory (SRAM), Double Data Rate Synchronous Dynamic Random Access Memory (DDR SDRAM), Low Power Double Data Rate4 (LPDDR4) SDRAM, Graphics Double Data Rate (GDDR) SDRAM, Low Power DDR (LPDDR), Rambus Dynamic Random Access Memory (RDRAM) device, or the like.

Because the operating speed of the second memory device 130 (e.g., the speed of a write operation or the speed of a read operation) is relatively fast compared to the operating speed of the first memory device 120, the memory controller 110 may quickly store or read logical addresses or mapping segments into the second memory device 130. Thus, the storage device 100 may use a region of the second memory device 130 as a cache region for the logical addresses or the mapping segments.

In FIG. 1, the second memory device 130 disposed external to the memory controller 110 is shown as an example, but the embodiments of the present disclosure are not limited thereto. The second memory device 130 may be included in the memory controller 110.

FIG. 2 is a block diagram of the storage device 100 according to an embodiment of the present disclosure. Referring to FIG. 2, the storage device 100 may include the memory controller 110, the first memory device 120, and the second memory device 130. The memory controller 110 may control the first memory device 120 and the second memory device 130. For example, the memory controller 110 may control the second memory device 130 such that data stored in the second memory device 130 is moved to the first memory device 120.

The memory controller 110 may include a computation unit 111 and a comparator 112. The computation unit 111 may perform various computational operations, and the comparator 112 may perform comparisons between the magnitudes of at least two values. For example, the computation unit 111 may compute variance values (e.g., a first variance value VV1) to be described further below, and the comparator 112 may perform comparison operations between the computed values or stored or determined values to determine which value is greater as a result.

The memory controller 110 may store data in the second memory device 130. For example, the memory controller 110 may receive a host request REQ and a logical address LBA from the host device 11 of FIG. 1, and may provide the logical address LBA to the second memory device 130 to store the logical address LBA in the second memory device 130. The memory controller 110 may store a plurality of logical addresses LBA1 to LBAn in the second memory device 130 as a single mapping segment MS. In some embodiments, the memory controller 110 may allocate the logical address LBA to one of a plurality of mapping segments MS, and store the logical address LBA as one mapping segment MS along with other logical addresses of the mapping segment to which the logical address LBA is allocated.

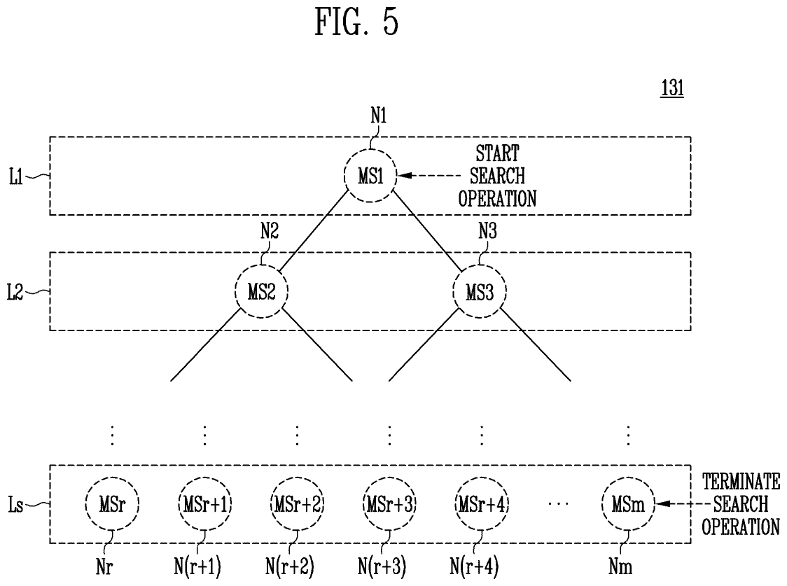

The memory controller 110 may perform a search operation. For example, before storing the logical address LBA or the mapping segment MS in the second memory device 130, the memory controller 110 may perform the search operation on the plurality of logical addresses LBA1 to LBAn or the plurality of mapping segments MS stored in the second memory device 130 to determine whether the logical address LBA is already stored in the second memory device 130. A more detailed description of the search operation will be described below with reference to FIG. 5.

When the logical address LBA is stored in the second memory device 130, the memory controller 110 may perform a map update operation. The memory controller 110 may control the second memory device 130 such that the plurality of logical addresses LBA1 to LBAn or mapping segments MS stored in the second memory device 130 are moved to the first memory device 120. When the logical address LBA is not stored in the second memory device 130, the memory controller 110 may store (or cache) the logical address LBA in the second memory device 130.

The memory controller 110 may compute a variance value of logical addresses included in each of the mapping segments MS (e.g., the first variance value VV1) stored in the second memory device 130. The variance value may indicate the degree of dispersion of the locations indicated by the logical addresses included in each of mapping segments. For example, the memory controller 110 may compute average values of the logical addresses included in each of the mapping segments MS, and may compute a variance value based on the average values. In some embodiments, the memory controller 110 may compute a standard deviation value of the logical addresses included in each of the mapping segments MS as the representation of dispersion degree of the locations indicated by the logical addresses.

The greater the variance value, the more dispersed the (logical) locations pointed to by the logical addresses stored in the second memory device 130 may be. When the locations pointed to by the logical addresses are more dispersed, a range covered by the search operation may be greater and a time required to perform the search operation may be longer. Accordingly, the memory controller 110 may perform a comparison operation between a variance value (e.g., the first variance value VV1) and a threshold value VT. In some embodiments, the memory controller 110 may omit the search operation based on the result of the comparison operation between the variance value (e.g., the first variance value VV1) and the threshold value VT.

For example, the memory controller 110 might not perform the search operation and may perform the map update operation when a variance value exceeds a threshold value. By omitting the search operation and performing the map update operation, the memory controller 110 may reduce the overhead and improve the performance of the storage device 100. The memory controller 110 may perform the search operation when the variance value does not exceed the threshold value.

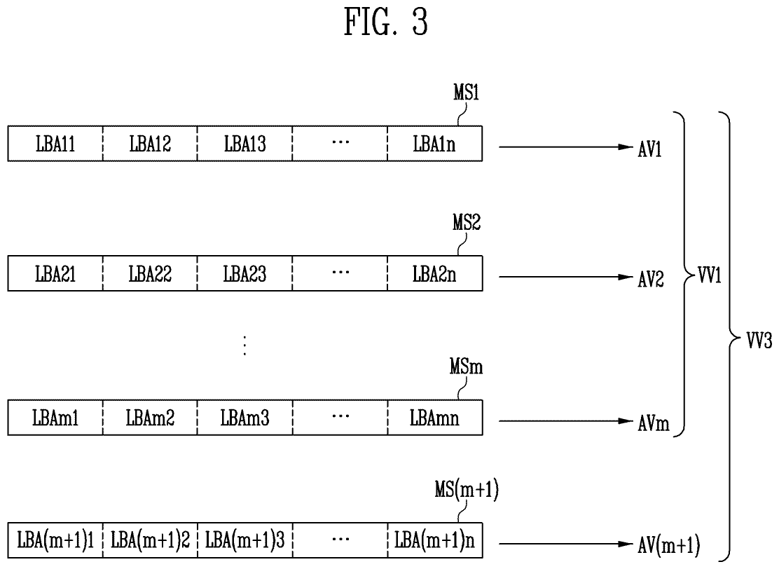

A more detailed description of the memory controller 110 computing the variance value will be described below with reference to FIG. 3.

In some embodiments, the memory controller 110 may compute the variance value of the mapping segments MS in a background operation. For example, the memory controller 110 may compute the variance value of the mapping segments MS prior to receiving the host request REQ and the logical address LBA from the host device 11. The memory controller 110 may compute the variance value and, in response to receiving the logical address from the host device 11, may perform a comparison operation between the computed variance value and the threshold value. The memory controller 110 may perform the map update operation or the search operation based on the result of the comparison operation.

The first memory device 120 is similar to the first memory device 120 of FIG. 1, and therefore, any repetitive descriptions thereof will be omitted.

The second memory device 130 may include first buffer memory 131. The first buffer memory 131 may store data. For example, the first buffer memory 131 may store logical addresses or mapping segments received from the memory controller 110. In some embodiments, the first buffer memory 131 may temporarily store the logical addresses or mapping segments, and may transfer the stored logical addresses or mapping segments to the first memory device 120 by the map update operation.

In some embodiments, the first buffer memory 131 may include a map tree. For example, the first buffer memory 131 may include a map tree in which a plurality of nodes are located on at least two layers. The map tree may allocate logical addresses or mapping segments to the plurality of nodes, respectively, and the plurality of nodes may be located on at least two layers. The first buffer memory 131 may store the logical addresses or mapping segments received from the memory controller 110 at the nodes of the map tree, respectively. A more detailed description of the map tree of the first buffer memory 131 will be described below with reference to FIG. 5.

However, the first buffer memory 131 storing the logical addresses or mapping segments in the form of a map tree is only one embodiment provided to facilitate the understanding of the present disclosure, and the first buffer memory 131 may also store the logical addresses or mapping segments (not in the form of a map tree but) sequentially.

The first buffer memory 131 may transfer the logical addresses or mapping segments to the first memory device 120 under the control (e.g., a map update operation) of the memory controller 110.

In a first operation \textcircled{1}, the memory controller 110 may compute the first variance value VV1. For example, the memory controller 110 may compute a first variance value of the mapping segments MS (or logical addresses) stored in the second memory device 130 or the first buffer memory 131.

In a second operation \textcircled{2}, the memory controller 110 may perform a first comparison operation between the first variance value VV1 and the threshold value VT. For example, the memory controller 110 may perform a first comparison operation to determine whether the first variance value VV1 computed in the first operation \textcircled{1} exceeds the threshold value VT.

In a third operation \textcircled{3}, the memory controller 110 may determine whether to perform a map update operation. For example, the memory controller 110 may perform the map update operation based on the result of the first comparison operation. In some embodiments, the memory controller 110 may determine that the first variance value VV1 exceeds the threshold value VT based on the result of the first comparison operation, and may perform the map update operation.

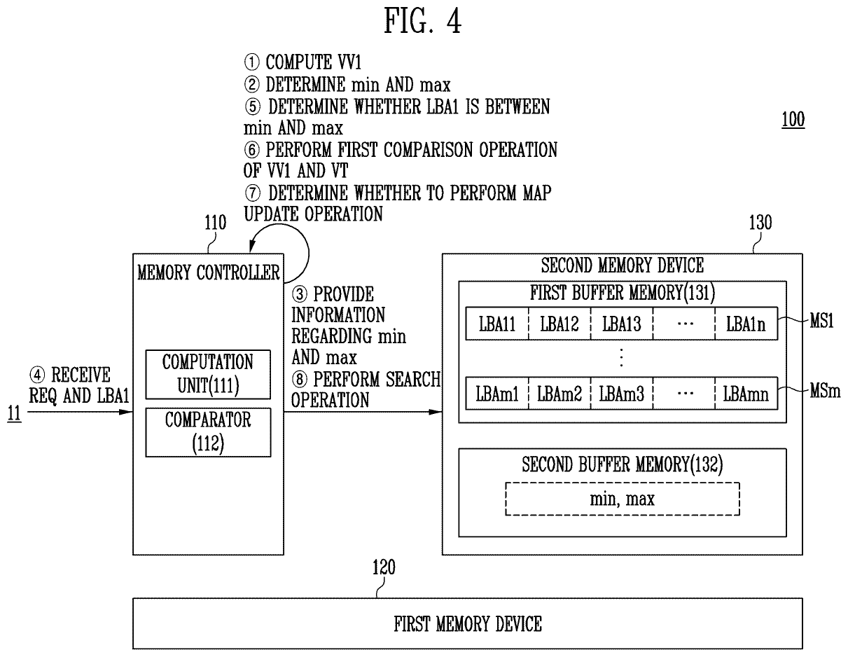

In some embodiments, the memory controller 110 may determine that the first variance value VV1 does not exceed the threshold value VT based on the result of the first comparison operation, and may perform a search operation on the mapping segments MS. In FIG. 2, a feature of performing the search operation on the mapping segments MS is not shown, but a more detailed description thereof will be described below with reference to FIGS. 4 and 5.

In a fourth operation \textcircled{4}, the memory controller 110 may control the second memory device 130 to perform the map update operation. For example, the memory controller 110 may omit the search operation based on the result of the first comparison operation and may control the second memory device 130 to transfer the mapping segments MS stored in the first buffer memory 131 to the first memory device 120. In some embodiments, the memory controller 110 may provide a control signal to the second memory device 130 to perform the map update operation.

In a fifth operation \textcircled{5}, the second memory device 130 may provide the mapping segments MS to the first memory device 120. For example, the second memory device 130 may provide the mapping segments MS stored in the first buffer memory 131 to the first memory device 120 under the control of the memory controller 110. In some embodiments, the second memory device 130 may erase the mapping segments MS stored in the first buffer memory 131 after providing the mapping segments MS to the first memory device 120.

In a sixth operation \textcircled{6}, the memory controller 110 may provide the second memory device 130 with the logical address LBA. For example, after the map update operation is performed (i.e., after the mapping segments MS stored in the first buffer memory 131 are erased), the memory controller 110 may provide the second memory device 130 with the logical address LBA or the mapping segment MS including the logical address LBA to store the logical address LBA received from the host device 11 in the first buffer memory 131.

In some embodiments, the second memory device 130 may store the logical address LBA or the mapping segment MS including the logical address LBA in the first buffer memory 131. For example, the second memory device 130 may store the logical address LBA or the mapping segment MS including the logical address LBA in the first buffer memory 131 in the form of a map tree or sequentially.

In a seventh operation \textcircled{7}, the memory controller 110 may compute a second variance value VV2. For example, the memory controller 110 may compute the second variance value VV2 when the logical address LBA or the mapping segment MS including the logical address LBA is stored in the first buffer memory 131 after the map update operation is performed. The second variance value VV2 may be a variance value of the mapping segments MS stored in the first buffer memory 131 after the map update operation is performed.

The storage device 100 may repeat the first to sixth operations \textcircled{1} to \textcircled{6}, i.e., the storage device 100 may compute a variance value of the mapping segments MS before receiving the host request REQ and the logical address LBA from the host device 11, perform a comparison operation between the variance value and a threshold value in response to receiving the host request REQ and the logical address LBA, and perform a map update operation or a search operation based on the result of the comparison operation.

The above-described first to seventh operations \textcircled{1} to \textcircled{7} are described to facilitate the understanding of the present disclosure, however the embodiments of the present disclosure are not limited thereto.

FIG. 3 is a diagram illustrating variance values of mapping segments according to some embodiments of the present disclosure. Referring to FIGS. 2 and 3, the second memory device 130 or the first buffer memory 131 may store a plurality of mapping segments MS1 to MS(m+1). The plurality of mapping segments MS1 to MS(m+1) may include a plurality of logical addresses LBA11 to LBA1n, LBA21 to LBA2n, . . . , LBAm1 to LBAmn, LBA(m+1)1 to LBA(m+1)n, respectively, where m and n are arbitrary positive integers.

The (m+1)-th mapping segment MS(m+1) may be a mapping segment further stored in the second memory device 130 or the first buffer memory 131 in which the first to m-th mapping segments MS1 to MSm are stored. The memory controller 110 may further store the (m+1)-th mapping segment MS(m+1) in the second memory device 130 or the first buffer memory 131 in which the first to m-th mapping segments MS1 to MSm are stored.

To facilitate the understanding of the present disclosure, the plurality of mapping segments MS1 to MS(m+1) are shown as including the same number (e.g., n) of logical addresses LBA11 to LBA1n, LBA21 to LBA2n, . . . , LBAm1 to LBAmn, LBA(m+1)1 to LBA(m+1)n, but the embodiments of the present disclosure are not limited thereto. The plurality of mapping segments MS1 to MS(m+1) may include different numbers of logical addresses.

The memory controller 110 may compute first to m-th average values AV1 to AVm to compute the first variance value VV1. The first to m-th average values AV1 to AVm may be average values of the logical addresses LBA11 to LBA1n, LBA21 to LBA2n, . . . , LBAm1 to LBAmn included in the first to m-th mapping segments MS1 to MSm, respectively. For example, the memory controller 110 may compute the average value of the first to n-th logical addresses LBA11 to LBA1n of the first mapping segment MS1 as the first average value AV1.

The memory controller 110 may compute the first variance value VV1 based on the first to m-th average values AV1 to AVm. In some embodiments, the memory controller 110 may compute a standard deviation value of the first to m-th average values AV1 to AVm as the first variance value VV1.

In some embodiments, the second memory device 130 or the first buffer memory 131 may store one logical address or one mapping segment. For example, after the sixth operation \textcircled{6} of FIG. 2, the second memory device 130 or the first buffer memory 131 may store one logical address or one mapping segment. In the seventh operation \textcircled{7} of FIG. 2, the memory controller 110 may compute the second variance value VV2. When the second memory device 130 or the first buffer memory 131 stores one logical address or one mapping segment, the second variance value VV2 may be zero.

The memory controller 110 may compute a third variance value VV3 based on the first to (m+1)-th average values AV1 to AV(m+1). In some embodiments, the memory controller 110 may compute the third variance value VV3 as a standard deviation value of the first to (m+1)-th average values AV1 to AV(m+1). The memory controller 110 may compute the third variance value VV3 when further storing the (m+1)-th mapping segment MS(m+1) in the second memory device 130 or the first buffer memory 131 which stores the first to m-th mapping segments MS1 to MSm.

FIG. 4 is a block diagram of the storage device 100 according to some embodiments of the present disclosure. Referring to FIG. 4, the storage device 100 may include the memory controller 110, the first memory device 120, and the second memory device 130. The memory controller 110, the first memory device 120, and the second memory device 130 of FIG. 4 are somewhat similar to the memory controller 110, the first memory device 120, and the second memory device 130 of FIG. 2, and therefore, any repetitive descriptions thereof will be omitted.

The memory controller 110 may determine a third logical address and a fourth logical address. The third and fourth logical addresses may correspond respectively to the minimum and maximum values among the logical addresses LBA11 to LBA1n, . . . , LBAm1 to LBAmn stored in the second memory device 130 or the first buffer memory 131.

For example, when the first logical address LBA11 of the first mapping segment MS1 corresponds to the minimum value among the logical addresses LBA11 to LBA1n, . . . , LBAm1 to LBAmn stored in the first buffer memory 131, the memory controller 110 may determine the first logical address LBA11 of the first mapping segment MS1 as the third logical address. When the n-th logical address LBAmn of the m-th mapping segment MSm corresponds to the maximum value among the logical addresses LBA11 to LBA1n, . . . , LBAm1 to LBAmn stored in the first buffer memory 131, the memory controller 110 may determine the n-th logical address LBAmn of the m-th mapping segment MSm as the fourth logical address.

In some embodiments, the memory controller 110 may determine the third logical address corresponding to the minimum value and the fourth logical address corresponding to the maximum value before receiving the host request REQ and the first logical address LBA1 from the host device 11. The memory controller 110 may minimize the overhead by determining the third logical address corresponding to the minimum value and the fourth logical address corresponding to the maximum value by a background operation.

The memory controller 110 may store information regarding the third logical address corresponding to the minimum value and the fourth logical address corresponding to the maximum value in the second memory device 130. In some embodiments, the memory controller 110 may store the information regarding the third logical address corresponding to the minimum value and the fourth logical address corresponding to the maximum value in second buffer memory 132. To facilitate the understanding of the present disclosure, the information regarding the third logical address and the fourth logical address is shown as being stored in the second buffer memory 132, but the embodiments of the present disclosure are not limited thereto. The information regarding the third logical address and the fourth logical address, along with the plurality of mapping segments MS1 to MSm, may be stored in the first buffer memory 131 or may be stored in the second memory device 130.

In some embodiments, upon receiving the host request REQ and the first logical address LBA1 from the host device 11, the memory controller 110 may determine whether the first logical address LBA1 is between the third logical address and the fourth logical address. The memory controller 110 may determine whether the first logical address LBA1 received from the host device 11 is within a range of logical locations of the logical addresses LBA11 to LBA1n, . . . , LBAm1 to LBAmn stored in the first buffer memory 131.

In some embodiments, the memory controller 110 may load the information regarding the third logical address and the fourth logical address stored in the second buffer memory 132 to determine whether the first logical address LBA1 is between the third logical address and the fourth logical address. Based on the loaded information regarding the third logical address and the fourth logical address, the memory controller 110 may determine whether the first logical address LBA1 is between the third logical address and the fourth logical address.

In some embodiments, the memory controller 110 may, in response to determining that the first logical address LBA1 received from the host device 11 is not between the third logical address and the fourth logical address, omit a search operation and store the first logical address LBA1 or a mapping segment including the first logical address LBA1 in the first buffer memory 131. Because the first logical address LBA1 not being between the third logical address and the fourth logical address indicates that a second logical address (not shown) identical to the first logical address LBA1 is not stored in the first buffer memory 131, the memory controller 110 may omit the search operation to determine whether the second logical address (not shown) identical to the first logical address LBA1 is stored in the first buffer memory 131. By omitting the search operation, the memory controller 110 may reduce the overhead and improve the performance of the storage device 100.

In some embodiments, the memory controller 110 may redetermine the third logical address and the fourth logical address. For example, after an additional logical address (e.g., the first logical address LBA1) is stored in the first buffer memory 131, the memory controller 110 may redetermine the third logical address corresponding to the minimum value and the fourth logical address corresponding to the maximum value among the logical addresses LBA11 to LBA1n, . . . , LBAm1 to LBAmn stored in the first buffer memory 131. The memory controller 110 may provide information regarding the redetermined third logical address and fourth logical address to the second memory device 130 or the second buffer memory 132.

In some embodiments, the memory controller 110 may perform a first comparison operation between the first variance value VV1 and the threshold value VT in response to determining that the first logical address LBA1 received from the host device 11 is between the third logical address and the fourth logical address. The memory controller 110 may perform a map update operation or perform a search operation based on the result of the first comparison operation.

In some embodiments, the memory controller 110 may perform the search operation. For example, the memory controller 110 may perform the search operation to determine whether a logical address indicating a specific logical location is stored in the logical addresses LBA11 to LBA1n, . . . , LBAm1 to LBAmn or the mapping segments MS1 to MSm stored in the first buffer memory 131. For example, in response to receiving the host request REQ and the first logical address LBA1 from the host device 11, the memory controller 110 may perform the search operation to determine whether the second logical address (not shown) identical to (or indicating the same logical location as) the first logical address LBA1 is stored in the first buffer memory 131 before storing the first logical address LBA1 in the first buffer memory 131.

However, when the first buffer memory 131 stores a significant number of logical addresses or mapping segments, the search operation may cause significant overhead. Therefore, when the first buffer memory 131 is likely to store a target logical address (e.g., when the target logical address is between the third logical address and the fourth logical address, and a variance value exceeds a threshold value), the memory controller 110 may omit the search operation and perform the map update operation. When the first buffer memory 131 is unlikely to store the target logical address (e.g., when the target logical address is not between the third logical address and the fourth logical address), the memory controller 110 may omit the search operation and store the target logical address in the first buffer memory 131.

The second memory device 130 may include the first buffer memory 131 and the second buffer memory 132. The first buffer memory 131 may store the mapping segments MS1 to MSm. The mapping segments MS1 to MSm may include the logical addresses LBA11 to LBA1n, . . . , LBAm1 to LBAmn, respectively.

The second buffer memory 132 may store the information regarding the third logical address and the fourth logical address. For example, the memory controller 110 may determine the third logical address corresponding to the minimum value and the fourth logical address corresponding to the maximum value among the logical addresses LBA11 to LBA1n, . . . , LBAm1 to LBAmn stored in the first buffer memory 131, and provide the information regarding the third logical address and the fourth logical address to the second memory device 130. The second buffer memory 132 may store the information regarding the third logical address and the fourth logical address.

The second buffer memory 132 may provide the memory controller 110 with the information regarding the third logical address and the fourth logical address in response to a load command from the memory controller 110. For example, when the memory controller 110 receives the host request REQ and the first logical address LBA1 from the host device 11, the memory controller 110 may load the information regarding the third logical address and the fourth logical address from the second buffer memory 132 to determine whether the first logical address LBA1 is between the third logical address and the fourth logical address. The second buffer memory 132 may provide the memory controller 110 with the information regarding the third logical address and the fourth logical address in response to the load command from the memory controller 110.

In a first operation \textcircled{1}, the memory controller 110 may compute the first variance value VV1. The first variance value VV1 may indicate the degree of dispersion of the average values of the logical addresses LBA11 to LBA1n, . . . , LBAm1 to LBAmn respectively included in the mapping segments MS1 to MSm stored in the first buffer memory 131.

In a second operation \textcircled{2}, the memory controller 110 may determine the third logical address and the fourth logical address. For example, the memory controller 110 may determine the third logical address corresponding to the minimum value and the fourth logical address corresponding to the maximum value among the logical addresses LBA11 to LBA1n, . . . , LBAm1 to LBAmn stored in the first buffer memory 131.

The order of the first operation \textcircled{1} and the second operation \textcircled{2} described herein is only one embodiment, and other embodiments of the present disclosure are not limited thereto. The memory controller 110 may perform the first operation \textcircled{1} and the second operation \textcircled{2} in a different order or simultaneously.

In a third operation \textcircled{3}, the memory controller 110 may provide the information regarding the third logical address and the fourth logical address to the second memory device 130. The second memory device 130 may store the information regarding the third logical address and the fourth logical address in the second buffer memory 132.

In a fourth operation \textcircled{4}, the memory controller 110 may receive the host request REQ and the first logical address LBA1 from the host device 11.

In a fifth operation \textcircled{5}, the memory controller 110 may determine whether the first logical address LBA1 is between the third logical address and the fourth logical address. For example, the memory controller 110 may determine whether the first logical address LBA1 is between the third logical address corresponding to the minimum value and the fourth logical address corresponding to the maximum value among the logical addresses LBA11 to LBA1n, . . . , LBAm1 to LBAmn stored in the first buffer memory 131.

In some embodiments, the memory controller 110 may load the information regarding the third logical address and the fourth logical address from the second memory device 130 or the second buffer memory 132 in response to receiving the host request REQ and the first logical address LBA1 from the host device 11. Based on the loaded information regarding the third logical address and the fourth logical address, the memory controller 110 may determine whether the first logical address LBA1 is between the third logical address and the fourth logical address.

In some embodiments, the memory controller 110 may store the first logical address LBA1 or the mapping segment including the first logical address LBA1 in the first buffer memory 131 in response to determining that the first logical address LBA1 is not between the third logical address and the fourth logical address. In response to determining that the first logical address LBA1 is not between the third logical address and the fourth logical address, the memory controller 110 may omit the search operation to determine whether the second logical address (not shown) identical to (or indicating the same logical location as) the first logical address LBA1 is stored in the first buffer memory 131.

In a sixth operation \textcircled{6}, the memory controller 110 may perform the first comparison operation between the first variance value VV1 and the threshold value VT. For example, the memory controller 110 may perform the first comparison operation of the first variance value VV1 and the threshold value VT in response to determining that the first logical address LBA1 is between the third logical address and the fourth logical address.

In a seventh operation \textcircled{7}, the memory controller 110 may determine whether to perform the map update operation. For example, the memory controller 110 may perform the map update operation based on the result of the first comparison operation. In some embodiments, the memory controller 110 may determine that the first variance value VV1 exceeds the threshold value VT based on the result of the first comparison operation, and may perform the map update operation.

In an eighth operation \textcircled{8}, the memory controller 110 may perform the search operation on the mapping segments MS. For example, the memory controller 110 may determine, based on the result of the first comparison operation, that the first variance value VV1 does not exceed the threshold value VT, and may perform the search operation on the mapping segments MS.

The memory controller 110 may perform the search operation to determine whether the second logical address (not shown) identical to (or indicating the same logical location as) the first logical address LBA1 is stored in the first buffer memory 131.

In some embodiments, the memory controller 110 may perform the map update operation in response to determining that the second logical address (not shown) is stored in the first buffer memory 131. After performing the map update operation, the memory controller 110 may store the first logical address LBA1 in the first buffer memory 131 and may erase the information regarding the third logical address and the fourth logical address stored in the second buffer memory 132.

In some embodiments, the memory controller 110 may provide the first logical address LBA1 to the second memory device 130 to store the first logical address LBA1 in the first buffer memory 131 in response to determining that the second logical address (not shown) is not stored in the first buffer memory 131. After the first logical address LBA1 is stored in the first buffer memory 131, the memory controller 110 may compute a second variance value, and may redetermine the third logical address and the fourth logical address. The memory controller 110 may provide information regarding the redetermined third logical address and fourth logical address to the second memory device 130.

The above-described first to eighth operations \textcircled{1} to \textcircled{8} are described to facilitate the understanding of the present disclosure, however the embodiments of the present disclosure are not limited thereto.

FIG. 5 is a diagram illustrating a map tree according to some embodiments of the present disclosure. Referring to FIG. 5, the first buffer memory 131 may store the plurality of mapping segments MS1 to MSm in the form of a map tree. The first buffer memory 131 may allocate the plurality of mapping segments MS1 to MSm to a plurality of nodes N1 to Nm, respectively. That is, one node may store one mapping segment.

In some embodiments, one mapping segment may include a plurality of logical addresses. For example, one logical address may have a size of 4 kilobytes (KB), and one mapping segment may include 1024 logical addresses. Thus, one mapping segment may have a size corresponding to a size of 1024 logical addresses. One node may be allocated to a mapping segment having the above-described size.

In some embodiments, the plurality of nodes N1 to Nm may be located on at least two layers L1 to Ls. For example, the first node N1 may be located on the first layer L1, the second and third nodes N2 and N3 may be located on the second layer L2, and the r-th to m-th nodes Nr to Nm may be located on the s-th layer Ls. m, s, and r are arbitrary positive integers.

To facilitate the understanding of the present disclosure, it is shown that two nodes are coupled to one node as an example, but the embodiments of the present disclosure are not limited thereto. At least two nodes may be coupled to one node.

The memory controller 110 of FIGS. 2 and 4 may perform a search operation on the mapping segments MS1 to MSm stored in the first buffer memory 131. For example, the memory controller 110 may perform the search operation to determine whether a second logical address, which is identical to (or which indicates the same logical location as) a first logical address received from the host device 11, is stored in the first buffer memory 131.

In some embodiments, the memory controller 110 may start the search operation at the first node N1 allocated to the first mapping segment MS1 and located on the first layer L1. The memory controller 110 may determine whether the second logical address is one of a plurality of logical addresses included in the first mapping segment MS1. In response to determining that the second logical address is not one of the plurality of logical addresses included in the first mapping segment MS1, the memory controller 110 may perform the search operation at the second and third nodes N2 and N3 located on the second layer L2. The memory controller 110 may perform the search operation in the similar manner on the r-th to m-th nodes Nr to Nm located on the s-th layer Ls, and terminate the search operation at the m-th node Nm.

The memory controller 110 may perform a map update operation when determining that the second logical address is present at the first to m-th nodes N1 to Nm, and may store the first logical address in the first buffer memory 131 when determining that the second logical address is not present at the first to m-th nodes N1 to Nm.

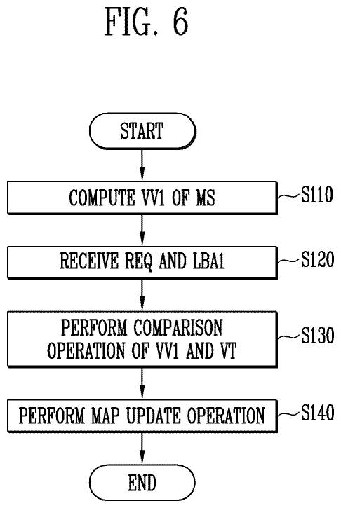

FIG. 6 is a flowchart illustrating a method of operating the storage device 100 according to embodiments of the present disclosure. Referring to FIGS. 2 and 6, the storage device 100 may perform a map update operation.

At operation S110, the storage device 100 or the memory controller 110 may compute the first variance value VV1 of the mapping segments MS. For example, the storage device 100 or the memory controller 110 may compute an average value of the logical addresses included in each of the mapping segments MS stored in the first buffer memory 131, and compute the first variance value VV1 based on the average values.

At operation S120, the storage device 100 or the memory controller 110 may receive the host request REQ and the first logical address LBA1 from the host device 11.

At operation S130, the storage device 100 or the memory controller 110 may perform a comparison operation between the first variance value VV1 and the threshold value VT. For example, the storage device 100 or the memory controller 110 may perform the comparison operation between the first variance value VV1 and the threshold value VT in response to receiving the host request REQ and the first logical address LBA1 from the host device 11.

At operation S140, the storage device 100 or the memory controller 110 may perform a map update operation. For example, the storage device 100 or the memory controller 110 may determine that the first variance value VV1 exceeds the threshold value VT based on the result of the comparison operation, and may perform the map update operation to move the mapping segments MS or the logical addresses stored in the first buffer memory 131 to the first memory device 120.

In some embodiments, after the map update operation is completed, the storage device 100 or the memory controller 110 may provide the first logical address LBA1 to the second memory device 130 to store the first logical address LBA1 in the first buffer memory 131.

When the first variance value VV1 exceeds the threshold value VT, the storage device 100 or the memory controller 110 may omit a search operation which requires significant overhead and perform the map update operation, thereby improving the performance of the storage device 100.

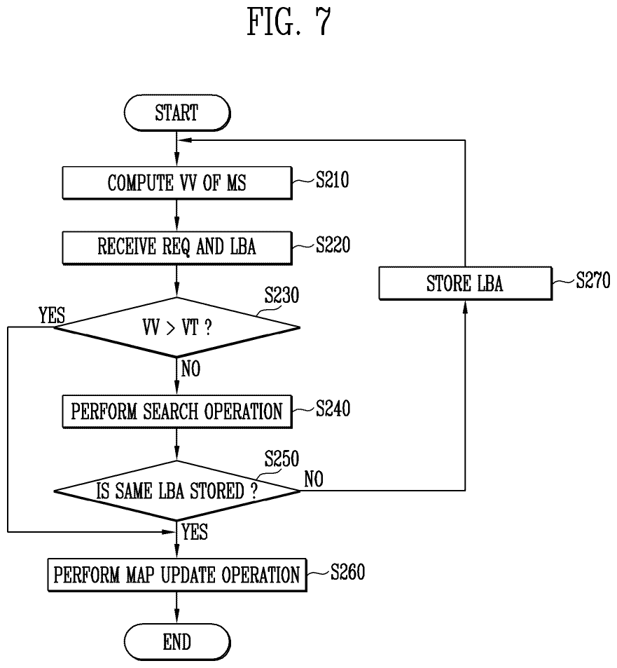

FIG. 7 is a flowchart illustrating a method of operating the storage device 100 according to some embodiments of the present disclosure. Referring to FIGS. 2 and 7, the storage device 100 may perform a map update operation.

At operation S210, the storage device 100 or the memory controller 110 may compute a variance value VV of the mapping segments MS. For example, the storage device 100 or the memory controller 110 may compute an average value of the logical addresses included in each of the mapping segments MS stored in the first buffer memory 131, and compute the variance value VV based on the average values.

At operation S220, the storage device 100 or the memory controller 110 may receive the host request REQ and the logical address LBA from the host device 11.

At operation S230, the storage device 100 or the memory controller 110 may perform a comparison operation between the variance value VV and the threshold value VT to determine whether the variance value VV exceeds the threshold value VT.

In some embodiments, the storage device 100 or the memory controller 110 may perform operation S260 in response to determining that the variance value VV exceeds the threshold value VT.

At operation S240, the storage device 100 or the memory controller 110 may perform a search operation. For example, the storage device 100 or the memory controller 110 may perform the search operation in response to determining that the variance value VV does not exceed the threshold value VT. The storage device 100 or the memory controller 110 may perform the search operation to determine whether a logical address, which is identical to (or which indicates the same logical location as) the logical address LBA received from the host device 11, is stored in the first buffer memory 131.

At operation S250, the storage device 100 or the memory controller 110 may determine, based on the result of the search operation, whether the logical address which is identical to (or which indicates the same logical location as) the logical address LBA received from the host device 11, is stored in the first buffer memory 131.

At operation S260, the storage device 100 or the memory controller 110 may perform a map update operation. For example, the storage device 100 or the memory controller 110 may perform the map update operation to move the mapping segments MS or the logical addresses stored in the first buffer memory 131 to the first memory device 120. The second memory device 130 may provide the mapping segments MS or the logical addresses to the first memory device 120.

In some embodiments, after the map update operation is completed, the storage device 100 or the memory controller 110 may provide the logical address LBA to the second memory device 130 to store the logical address LBA in the first buffer memory 131.

At operation S270, the storage device 100 or the second memory device 130 may store the logical address LBA. For example, the storage device 100 or the memory controller 110 may provide the logical address LBA to the second memory device 130 to store the logical address LBA in the first buffer memory 131 in response to determining that a logical address, which is identical to (or which indicates the same logical location as) the logical address LBA received from the host device 11, is not stored in the first buffer memory 131.

In some embodiments, operation S210 may be performed after the logical address LBA is stored in the first buffer memory 131. After the logical address LBA is stored in the first buffer memory 131, the storage device 100 or the second memory device 130 may compute the variance value VV of the mapping segments MS in which the logical address LBA is further stored.

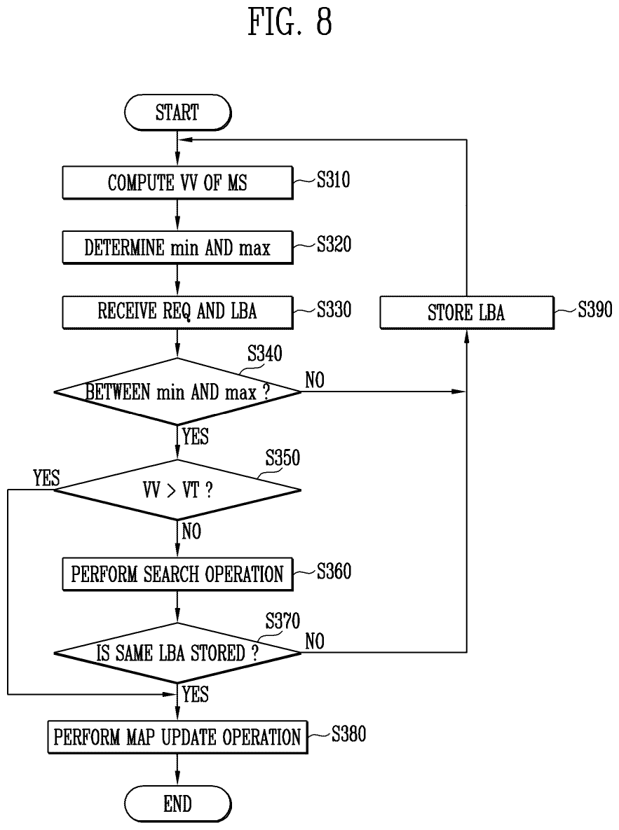

FIG. 8 is a flowchart illustrating a method of operating the storage device 100 according to some embodiments of the present disclosure. Referring to FIGS. 4 and 8, the storage device 100 may perform a map update operation.

At operation S310, the storage device 100 or the memory controller 110 may compute the variance value VV of the mapping segments MS. For example, the storage device 100 or the memory controller 110 may compute an average value of the logical addresses included in each of the mapping segments MS stored in the first buffer memory 131, and compute the variance value VV based on the average values.

At operation S320, the storage device 100 or the memory controller 110 may determine the third logical address corresponding to the minimum value and the fourth logical address corresponding to the maximum value among the logical addresses stored in the first buffer memory 131. In some embodiments, the storage device 100 or the memory controller 110 may store information regarding the third logical address and the fourth logical address in the second buffer memory 132.

The storage device 100 or the memory controller 110 may perform operations S310 and S320 in a different order or simultaneously.

At operation S330, the storage device 100 or the memory controller 110 may receive the host request REQ and the logical address LBA from the host device 11.

At operation S340, the storage device 100 or the memory controller 110 may determine whether the logical address LBA received from the host device 11 is between the third logical address and the fourth logical address. The storage device 100 or the memory controller 110 may determine whether the logical address LBA received from the host device 11 is within the range of logical addresses stored in the first buffer memory 131. When the logical address LBA is determined as falling within the range of logical addresses stored in the first buffer memory 131, it may be regarded that a physical location corresponding to the logical address LBA falls within a range of physical locations corresponding to the logical addresses stored in the first buffer memory 131.

In some embodiments, the storage device 100 or the memory controller 110 may load the information regarding the third logical address and the fourth logical address stored in the second buffer memory 132, and determine whether the logical address LBA is between the third logical address and the fourth logical address based on the loaded information.

In some embodiments, in response to determining that the logical address LBA is not between the third logical address and the fourth logical address, the storage device 100 may perform operation S390.

Operations S350 to S390 are similar to operations S230 to S270 described above with reference to FIG. 7, and therefore, repetitive descriptions thereof will be omitted.

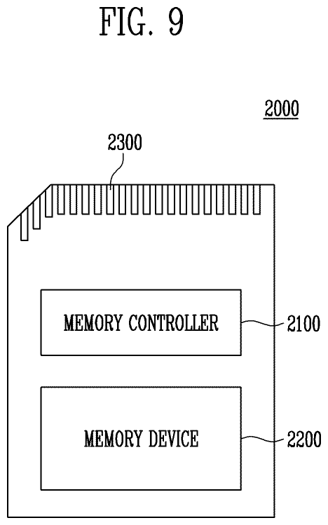

FIG. 9 is a block diagram illustrating a memory card system 2000 to which a storage device according to some embodiments of the present disclosure is applied. Referring to FIG. 9, the memory card system 2000 may include a memory controller 2100, a memory device 2200, and a connector 2300.

The memory controller 2100 may be coupled to the memory device 2200. The memory controller 2100 may be configured to access the memory device 2200. For example, the memory controller 2100 may be configured to control read, write, erase, and background operations of the memory device 2200. The memory controller 2100 may be configured to provide an interface between the memory device 2200 and the host device 11 of FIG. 1. The memory controller 2100 may be configured to drive firmware for controlling the memory device 2200. The memory controller 2100 may be formed similarly to the memory controller 110 described with reference to FIG. 1.

For example, the memory controller 2100 may include components such as Random Access Memory (RAM), a processing unit, a host interface, a memory interface, and an error correction circuit.

The memory controller 2100 may communicate with an external device via the connector 2300. For example, the memory controller 2100 may communicate with an external device (e.g., the host device 11 of FIG. 1) through at least one of various communication standards or interfaces such as a Universal Serial Bus (USB), a Multi-Media Card (MMC), an embedded MMC (eMMC), a Peripheral Component Interconnect (PCI), PCI-express (PCI-e), Advanced Technology Attachment (ATA), Serial-ATA (SATA), Parallel-ATA (PATA), a Small Computer System Interface (SCSI), an Enhanced Small Disk Interface (ESDI), Integrated Drive Electronics (IDE), Firewire, Universal Flash Storage (UFS), Wi-Fi, Bluetooth, and/or Non-Volatile Memory express (NVMe). For example, the connector 2300 may be defined by at least one of the various communication standards or interfaces described above.

For example, the memory device 2200 may be embodied as one of various non-volatile memory elements, such as Electrically Erasable and Programmable ROM (EEPROM), NAND flash memory, NOR flash memory, Phase-change RAM (PRAM), Resistive RAM (ReRAM), Ferroelectric RAM (FRAM), and/or Spin-Transfer Torque Magnetic RAM (STT-MRAM). The memory device 2200 may be formed similarly to the first memory device 120 described with reference to FIG. 1.

The memory controller 2100 and the memory device 2200 may be integrated into a single semiconductor device to form a memory card. For example, the memory controller 2100 and the memory device 2200 may be integrated into a single semiconductor device to form a memory card, such as a Personal Computer Memory Card International Association (PCMCIA), a Compact Flash (CF) card, a smart media card (SM, SMC), a memory stick, a multimedia card (MMC, RS-MMC, MMCmicro, eMMC), an SD card (SD, miniSD, microSD, SDHC), or Universal Flash Storage (UFS).

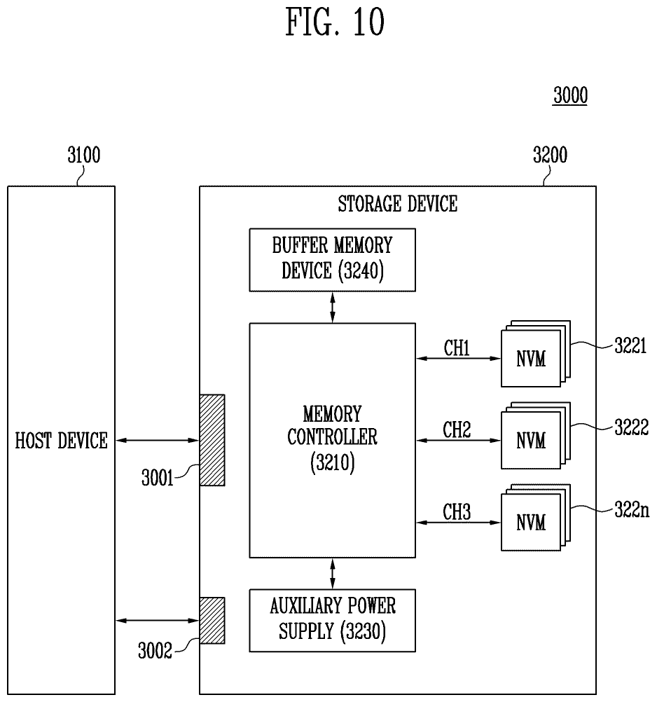

FIG. 10 is a block diagram illustrating an electronic system 3000 according to some embodiments of the present disclosure. Referring to FIG. 10, the electronic system 3000 may include a host device 3100 and a storage device 3200. The storage device 3200 may send and receive signals to and from the host device 3100 via a signal connector 3001 and receive power via a power connector 3002. The storage device 3200 may include a memory controller 3210, a plurality of non-volatile memory devices 3221 to 322n, an auxiliary power supply 3230, and a buffer memory device 3240.

According to an embodiment of the present disclosure, the memory controller 3210 may perform the functions of the memory controller 110 of FIG. 2.

The memory controller 3210 may control the plurality of non-volatile memory devices 3221 to 322n in response to signals received from the host device 3100. For example, the signals may be based on an interface of the host device 3100 and the storage device 3200. For example, the signals may be defined by at least one of communication standards or interfaces, such as Universal Serial Bus (USB), Multi-Media Card (MMC), embedded MMC (eMMC), Peripheral Component Interconnect (PCI), PCI-express (PCI-e), Advanced Technology Attachment (ATA), Serial-ATA (SATA), Parallel-ATA (PATA), Small Computer System Interface (SCSI), Enhanced Small Disk Interface (ESDI), Integrated Drive Electronics (IDE), Firewire, Universal Flash Storage (UFS), Wi-Fi, Bluetooth, or Non-Volatile Memory express (NVMe) interfaces.

The auxiliary power supply 3230 may be coupled to the host device 3100 via the power connector 3002. The auxiliary power supply 3230 may receive a power voltage from the host device 3100 and may be charged. The auxiliary power supply 3230 may provide a power voltage to the storage device 3200 when the power supply from the host device 3100 is not smooth. For example, the auxiliary power supply 3230 may be located within the storage device 3200 or may be located outside the storage device 3200. For example, the auxiliary power supply 3230 may be located on a main board and may provide auxiliary power to the storage device 3200.

The buffer memory device 3240 may operate as buffer memory for the storage device 3200. For example, the buffer memory device 3240 may temporarily store data received from the host device 3100 or data received from the plurality of non-volatile memory devices 3221 to 322n, or may temporarily store metadata (e.g., a mapping table) of the plurality of non-volatile memory devices 3221 to 322n. The buffer memory device 3240 may include volatile memory, such as DRAM, SDRAM, DDR SDRAM, or LPDDR SDRAM, or non-volatile memory, such as FRAM, ReRAM, STT-MRAM, or PRAM.

According to embodiments of the present disclosure, a storage device performing a map update operation, a method of operating the storage device, and a method of operating an electronic system including the storage device are provided.

Also, a storage device, which reduces the latency and improves the performance by performing a map update operation without a search operation, based on the degree of dispersion of logical addresses, a method of operating the storage device, and a method of operating an electronic system including the storage device are provided.

The above-mentioned descriptions are specific embodiments to practice the present disclosure, however, the present disclosure does not only include the embodiments described above, but also embodiments which may be redesigned or modified. The present disclosure also includes techniques which may be modified and practiced using the disclosed embodiments. Therefore, the scope of the present disclosure should not be limited to the embodiments described above, but should be determined by the appended claims as well as their equivalents. Furthermore, the embodiments may be combined to form additional embodiments.

What is claimed is:

1. A storage device comprising:
a first memory device;
a second memory device including a first buffer memory configured to store a plurality of mapping segments each including a plurality of logical addresses; and
a memory controller configured to:
perform a map update operation to move the plurality of mapping segments from the second memory device to the first memory device,
compute a first variance value of the plurality of logical addresses included in each of the plurality of mapping segments,
perform a first comparison operation between the first variance value and a threshold value, and
determine whether to perform the map update operation based on a result of the first comparison operation.

2. The storage device of claim 1, wherein the memory controller is configured to:
compute average values of the plurality of logical addresses corresponding to respective ones of the plurality of mapping segments; and
compute the first variance value based on the average values.

3. The storage device of claim 1, wherein the memory controller is configured to:
receive a host request and a first logical address from an external host device;
perform the first comparison operation in response to receiving the host request and the first logical address; and
determine, based on the result of the first comparison operation, whether to perform the map update operation before storing the first logical address in the first buffer memory.

4. The storage device of claim 1, wherein the memory controller is configured to:
perform, in response to determining that the first variance value is greater than the threshold value, the map update operation; and
perform, in response to determining that the first variance value is not greater than the threshold value, a search operation to determine whether a second logical address, which is identical to a first logical address received from an external host device, is stored in the first buffer memory.

5. The storage device of claim 4, wherein the memory controller is configured to:
perform the map update operation in response to determining that the second logical address is stored in the first buffer memory based on a result of the search operation; and
store the first logical address in the first buffer memory in response to determining that the second logical address is not stored in the first buffer memory.

6. The storage device of claim 5, wherein the memory controller is configured to:
allocate the first logical address to one of the plurality of mapping segments to store the first logical address in the first buffer memory;
compute a second variance value of the plurality of logical addresses included in each of the plurality of mapping segments including the first logical address; and
perform a second comparison operation between the second variance value and the threshold value, and determine, based on a result of the second comparison operation, whether to perform the map update operation.

7. The storage device of claim 4, wherein the first buffer memory includes a map tree which allocates the plurality of mapping segments to a plurality of nodes, respectively, and in which the plurality of nodes are located on two or more layers, and
wherein the memory controller is configured to perform the search operation to determine whether the second logical address is stored in one or more of the plurality of nodes.

8. The storage device of claim 4, wherein the memory controller is configured to perform the search operation sequentially on the plurality of mapping segments to determine whether the second logical address is stored in the first buffer memory.

9. The storage device of claim 1, wherein the memory controller is configured to:
determine third and fourth logical addresses respectively corresponding to a minimum value and a maximum value among the plurality of logical addresses included in each of the plurality of mapping segments; and
perform the first comparison operation in response to determining that a first logical address received from an external host device is between the third logical address and the fourth logical address.

10. The storage device of claim 9, wherein the second memory device includes a second buffer memory, and
wherein the memory controller is configured to store information regarding the third logical address and the fourth logical address in the second buffer memory.

11. A method of operating a storage device, the method comprising:
computing, by a memory controller, a first variance value of the plurality of logical addresses included in each of a plurality of mapping segments stored in a first buffer memory of a second memory device;
receiving, by the memory controller, a host request and a first logical address from an external host device;
performing, by the memory controller, a first comparison operation between the first variance value and a threshold value; and
performing, by the memory controller, a map update operation in response to determining that the first variance value is greater than the threshold value,
wherein the plurality of mapping segments each include a plurality of logical addresses, and
wherein the map update operation moves the plurality of mapping segments from the second memory device to a first memory device.

12. The method of claim 11, wherein computing the first variance value comprises:
computing, by the memory controller, average values of the plurality of logical addresses corresponding to respective ones of the plurality of mapping segments; and
computing, by the memory controller, the first variance value based on the average values.

13. The method of claim 11, wherein performing the first comparison operation includes performing, by the memory controller, in response to determining that the first variance value is not greater than the threshold value, a search operation to determine whether a second logical address identical to the first logical address is stored in the first buffer memory.

14. The method of claim 13, further comprising:
determining, by the memory controller, based on a result of the search operation, that the second logical address is stored in the first buffer memory; and
performing, by the memory controller, the map update operation.

15. The method of claim 13, further comprising:
determining, by the memory controller, based on a result of the search operation, that the second logical address is not stored in the first buffer memory;
allocating, by the memory controller, the first logical address to one of the plurality of mapping segments; and
computing, by the memory controller, a second variance value of the plurality of logical addresses included in each of the plurality of mapping segments including the first logical address.

16. The method of claim 13, wherein the first buffer memory includes a map tree allocating the plurality of mapping segments to a plurality of nodes, respectively, and
wherein performing the search operation includes determining, by the memory controller, whether the second logical address is stored in one or more of the plurality of nodes.

17. The method of claim 11, wherein performing the first comparison operation comprises:
determining, by the memory controller, third and fourth logical addresses respectively corresponding to a minimum value and a maximum value among the plurality of logical addresses included in each of the plurality of mapping segments; and
performing, by the memory controller, the first comparison operation in response to determining that the first logical address is between the third logical address and the fourth logical address.

18. The method of claim 17, wherein the second memory device includes second buffer memory, and
wherein determining the third logical address and the fourth logical address includes storing, by the memory controller, the third logical address and the fourth logical address in the second buffer memory.

19. A method of operating an electronic system, the method comprising:
computing, by a storage device, a first variance value of the plurality of logical addresses included in each of a plurality of mapping segments stored in a first buffer memory of a second memory device in the storage device;
transferring, by a host device, a host request and a first logical address to the storage device;
performing, by the storage device, a first comparison operation between the first variance value and a threshold value in response to receiving the host request and the first logical address from the host device; and
performing, by the storage device, a map update operation in response to determining that the first variance value is greater than the threshold value,
wherein the plurality of mapping segments each include a plurality of logical addresses, and
wherein the map update operation moves the plurality of mapping segments from the second memory device to a first memory device.

20. The method of claim 19, wherein performing the first comparison operation comprises:
determining, by the storage device, third and fourth logical addresses respectively corresponding to a minimum value and a maximum value among the plurality of logical addresses included in each of the plurality of mapping segments; and
performing, by the storage device, the first comparison operation in response to determining that the first logical address is between the third logical address and the fourth logical address.
